(19) United States
(12) Patent Application Publication
(10) Pub. No.: US 2026/0186983 A1
(43) Pub. Date: Jul. 2, 2026

(54) REDIRECTING PERIPHERAL DEVICES BETWEEN REMOTE DESKTOPS

(71) Applicant: Omnissa, LLC, Mountain View, CA (US)

(72) Inventor: Lin LV, Beijing (CN)

(21) Appl. No.: 18/577,200

(22) PCT Filed: Oct. 16, 2023
(86) PCT No.: PCT/CN2023/124651

§ 371 Date: Jan. 5, 2024

(30) Foreign Application Priority Data
Oct. 16, 2023 (WO) PCT/CN2023/124651

(51) Int. Cl. G06F 13/10

(52) U.S. Cl. CPC G06F 13/10; G06F 2213/40

(57) ABSTRACT

Systems and methods are provided for redirecting peripheral devices between different remote desktops. A user can establish a virtual desktop session on remote desktop A via a virtual desktop client operating on the user's local client device. After the remote desktop session is established, any of various peripheral devices such as a printer, camera, USB device, etc. can be redirected to virtual desktop A to enable the user to access those devices in virtual desktop A. The user can request virtual desktop A to redirect the peripheral device to virtual desktop B. After the peripheral device is successfully redirected to desktop B from desktop A, the user of desktop B (whether the same user or a different user) can find and see the shared device on remote desktop B and use the peripheral device in desktop B like other devices that are redirected to desktop B from a local device.

### TECHNICAL FIELD

The present disclosure generally relates to virtual desktop infrastructure and more specifically to techniques for using peripheral devices connected to a client device in virtual desktop sessions.

### BACKGROUND OF THE INVENTION

Virtual desktops provided as part of a virtual desktop infrastructure (VDI) or desktop-as-a-service (DAAS) offerings are becoming more commonplace in today's enterprise work environments. The security of having a remotely stored desktop, ability to access the desktop from any location and on any device, centralized desktop management, efficient use of hardware resources, as well as numerous other benefits made possible by VDI/DAAS are a large benefit for many organizations.

In a conventional VDI or DAAS environment, each user in an enterprise is provisioned a virtual desktop and is allowed to access his or her virtual desktop over a remote network connection, such as a WAN connection. The virtual desktops are typically hosted on servers that reside in a data center of the enterprise or a third-party service provider, and each host server may execute multiple virtual desktops. Users can utilize a client device to remotely log into their individual virtual desktop and all of the application execution takes place on the remote host server which is linked to the local client device over a network using a remote display protocol, such as Remote Desktop Protocol (RDP), PC-over-IP protocol (PCoIP), virtual network computing (VNC) protocol, or the like. Using the remote display protocol, the user can interact with applications of the virtual desktop, which are running on the remote host server, with only the display, keyboard, and mouse information communicated with the local client device. A common implementation of this approach is to host multiple desktop operating system instances on separate virtual machines deployed on a server hardware platform running a hypervisor.

In various virtual desktop products, peripheral devices on the local device can be redirected to the remote desktop so that the user can use these devices on their remote desktops. For example, the user can print documents from the virtual desktop to a printer on the client device, access USB devices attached to the client device in the virtual desktop, use a camera or microphone of the client device in the virtual desktop, etc. However, with past technology there was no way to share peripheral devices between two different remote desktops, which may belong to the same user or to different users. Indeed, if peripheral devices could be shared between remote desktops, it could significantly improve the efficiency of remote working and collaboration between users.

For example, user A may be working on a remote desktop and need to print a document but there is no printer connected to their remote desktop. User B may have a printer connected to their remote desktop but there is no easy way to share the printer with user A.

User A may want to share some large files located on their USB disk with user B, but the users are not working in the same location. They may be able to share files via a file server or communication apps but it is inconvenient since there may be many files and some files may be large. The file transfer using traditional methods requires several steps and is time-consuming.

A user may have two local devices with each local device connecting to a different remote desktop. Local device A is connecting to remote desktop A while local device B is connecting to Remote Desktop B. The user may need to connect different local devices to different remote desktops because different local devices may have different peripheral devices (printers, microphones, USB, etc.) and the user may need to use all of these peripheral devices during daily work. The pain point is that this user can't use the peripheral devices together on the same remote desktop if these devices are located on different local machines.

What is needed is a way of redirecting peripheral devices between different remote desktops.

### BRIEF DESCRIPTION OF DRAWINGS

FIG. 1 illustrates an example of a virtual desktop environment, in accordance with various embodiments.

FIG. 2 illustrates an example architecture of a system for redirecting peripheral devices between remote desktops, in accordance with various embodiments.

FIG. 3 is an illustration of a process flow between virtual desktop A, the connection server, and virtual desktop B, in accordance with various embodiments.

FIG. 4 illustrates an example of some general components of a computing device, in accordance with various embodiments.

### DETAILED DESCRIPTION OF THE INVENTION

Systems and methods in accordance with various embodiments of the present disclosure overcome at least some of the above-mentioned shortcomings and deficiencies by providing efficient ways for redirecting peripheral devices between different remote desktops. The process can begin by a user establishing a virtual desktop session on remote desktop A via a virtual desktop client operating on the user's local client device. After the remote desktop session is established, any of various peripheral devices on the client device such as a printer, camera, USB device, etc. can be redirected to virtual desktop A to enable the user to access those devices in virtual desktop A. If the user then desires one of the peripheral device to be accessible in a different desktop, virtual desktop B, which may belong to the same user or to a different user, the user can request virtual desktop A to redirect the peripheral device to virtual desktop B.

For example, via a user interface (UI) on virtual desktop A, the user can select the peripheral device that they wish to redirect to virtual desktop B form a list of peripheral devices available on virtual desktop A, which may be audio devices, cameras, keyboards, mice and other pointing devices, printers, USB devices, etc. The available device may be physical devices connected to the user's client device which have been redirected to virtual desktop A as mentioned above. After the user identifies the peripheral device that they wish to redirect to another desktop, the user can identify the target desktop to which they wish to redirect the device (i.e., virtual desktop B). The user can be provided with a list of user or of available desktops (e.g., listed by the desktop owner's name) and be asked to select the target user or desktop to which the peripheral device should be redirected to from the list. The user can also be provided with a search bar to search for the target desktop they wish to redirect the peripheral device to.

Once the user identifies the device they wish to share and the target user or virtual desktop (in this case, user B or virtual desktop B), an invitation can be sent to virtual desktop B to accept the redirection of the peripheral device. Once the invitation is accepted, the peripheral device can be redirected to virtual desktop B from virtual desktop A. For example, a prompt or dialog can be presented on virtual desktop B (e.g., produced by the virtual desktop agent of desktop B) asking user B of virtual desktop B to accept or reject the sharing request for the peripheral device from desktop A.

After the peripheral device is successfully redirected to desktop B from desktop A, the user of desktop B (whether the same user or a different user) can find and see the shared device on remote desktop B and use the peripheral device in desktop B just like other devices that are redirected to desktop B from a local device (e.g., the local device being used to access desktop B).

In various embodiments, a device-sharing UI can be provided in desktop A (e.g., by the virtual desktop agent of desktop A), which can display to the user of desktop A what peripheral devices are being shared with other desktops and give the user the option to terminate the sharing of any particular peripheral device with other desktops such as desktop B. The peripheral device sharing will be ended if the user of desktop A terminates the sharing via this interface, or if the user disconnects from desktop A.

In various embodiments, a device-sharing UI can be provided in desktop B (e.g., by the virtual desktop agent of desktop B), which can display to the user of desktop B what peripheral devices are being shared with it from other desktops and give the user the option to terminate the sharing of any particular peripheral device by other desktops such as desktop A. The peripheral device sharing will be ended if the user of desktop B terminates the sharing via this interface, or if the user disconnects from desktop B.

With this solution, a user can share peripheral devices that are redirected to the user's virtual desktop from the user's local device with virtual desktops of other users. The same user can also share peripheral devices between different desktops belonging to the user. A user can redirect multiple devices to the same remote desktop. Users can share one device to multiple remote desktops as long as that device supports multiple sharing. For example, a printer and a USB device may be sharable to multiple remote desktops, while a camara may only be shareable with one remote desktop at the same time.

As used throughout this disclosure in the context of remote desktop environments, the terms, “desktop”, “remote desktop”, and “virtual desktop” are used interchangeably and refer to an instance of an operating system and/or applications that run(s) remotely with respect to the user. In a conventional VDI or DAAS environment, each virtual desktop corresponds to a virtual machine (VM) executed on a host server (i.e., a host computing device) that is physically located in a remote datacenter. Each host server may host any number of virtual machines (e.g., tens, hundreds, etc.) and each virtual machine may be owned by an individual user. The virtual machine typically includes a guest operating system (e.g., Windows) capable of executing applications for the user and the virtual machine is used to provide a virtual desktop for the individual user. The user who owns the virtual desktop can remotely log into his or her virtual desktop using a client device that establishes a network connection (e.g., Wide Area Network connection) with the host server and remotely execute various applications on the virtual machine as if the desktop was running on the user's local client device. The client device can be any computing device capable of establishing a network connection, including but not limited to personal computers (PCs), laptops, mobile phones, tablet computers, wearable devices (e.g., smart watches, electronic smart glasses, etc.) or the like.

When a client device is accessing a remote desktop using a remote display protocol (e.g., RDP, PCoIP, VNC, etc.), the graphical user interface (GUI) of the desktop is generated on the server, the GUI image data is then encoded and transmitted over the network to the client device, where it is decoded and displayed to the user. For example, in one embodiment, the framebuffer pixel data on the server is encoded using a codec, such as H264, and transmitted over an Internet connection to the client, where the data is decoded and rendered on a local display screen to the user. Similarly, any user input information, such as keyboard and mouse events, is transmitted from the client device to the server over the network connection, where it may in turn cause various updates to the GUI of the remote desktop. In this manner, the user is able to view the GUI of the remote desktop and interact with it as if the desktop was actually running on the local client device, even though the desktop is actually executing remotely.

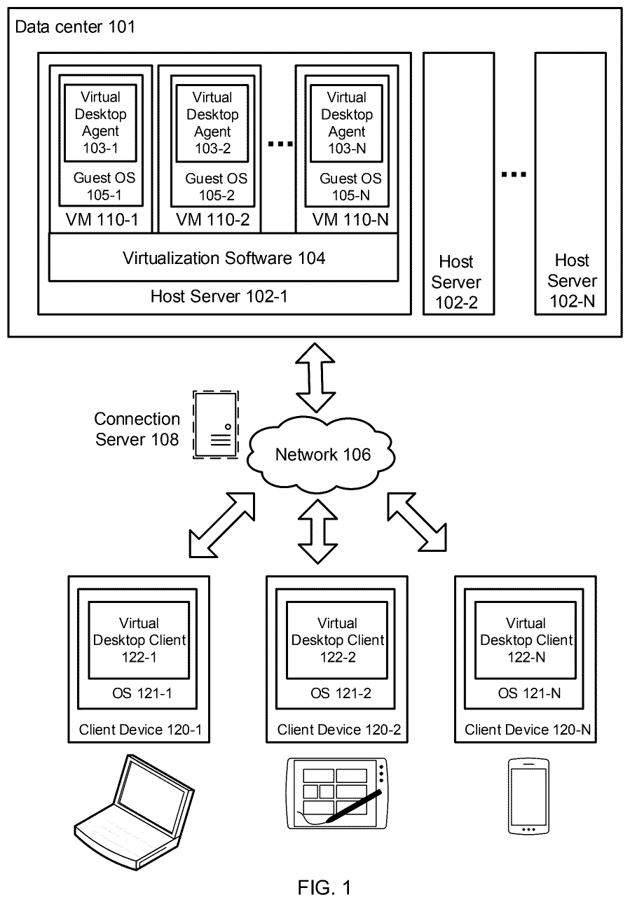

FIG. 1 illustrates an example of a virtual desktop environment, in accordance with various embodiments. The virtual desktop environment, such as VDI or DAAS environment, includes host servers (102-1, 102-2, 102-N) that are communicatively coupled with a number of client devices (120-1, 120-2, 120-N) via a network 106. The client devices (120-1, 120-2, 120-N) establish virtual desktop sessions with the host servers (102-1, 102-2, 102-N) by first contacting the connection server 108. In various embodiments, the connection server 108 acts as a broker for client connections by authenticating users through Windows Active Directory (AD) and directing the request to the appropriate host server hosting the virtual machine running the virtual desktop that the user is entitled to access.

Network 106 may be a wide area network (WAN), or other form of remote communication link between the host servers (102-1, 102-2, 102-N) and client devices (120-1, 120-2, 120-N). Network 106 may further include numerous other components, such as one or more firewalls, management servers, etc., which are not shown here so as not to obscure salient features of the virtual desktop environment. Host servers (102-1, 102-2, 102-N) may physically reside in a data center 101 of the enterprise (e.g., in case of VDI) or in a data center of a third-party service provider (e.g., in case of DAAS). The connection server 108 can be deployed inside the corporate firewall or may be deployed as a security server in the demilitarized zone (DMZ) or may be deployed in various other locations.

Once the virtual desktop sessions have been established, host server 102-1 can interoperate with client devices (120-1, 120-2, 120-N) to provide virtual desktop services to users of client devices (120-1, 120-2, 120-N). For example, host server 102-1 can host, for each user, a desktop that is presented by a guest operating system (such as one of the guest operating systems 105-1, 105-2, 105-N) running on a virtual machine (such as one of the virtual machines 110-1, 110-2, 110-N) on host server 102-1. In this context, the terms “desktop”, “remote desktop”, and “virtual desktop” refer to a computing environment in which a user can launch, interact with, and manage the user's applications, settings, and data. Each client device (120-1, 120-2, 120-N) can allow a user to view on a desktop graphical user interface (on a local client device) his/her desktop that is running remotely on host server 102-1, as well as provide commands for controlling the desktop. In this manner, the users of client devices (e.g., 120-1, 120-2, 120-N) can interact with the desktops hosted on host server 102-1 as if the desktops were executing locally on client devices (120-1, 120-2, 120-N).

In the embodiment of FIG. 1, host server 102-1 includes virtualization software 104 that supports the execution of one or more virtual machines (VMs) (e.g., 110-1, 110-2, 110-N). The virtualization software 104 may be a hypervisor, a virtual machine manager (VMM) or other software that allows multiple virtual machines to share the physical resources of the server. In the illustrated embodiment, each virtual machine (e.g., 110-1, 110-2, 110-N) can execute a guest operating system (e.g., 105-1, 105-2, 105-N) that hosts a desktop for a single user at a time. For example, if five users connect to host server 102-1 for the purpose of initiating remote desktop sessions, the host server 102-1 can launch five VMs, each VM hosting a desktop for each individual user. These types of virtual desktop environments where user desktops are hosted within separate, server-side virtual machines are often referred to as virtual desktop infrastructure (VDI) or Desktop-as-a-Service (DAAS) environments.

In such virtual desktop environments, each client device (e.g., 120-1, 120-2, 120-N) can execute a virtual desktop client (e.g., 122-1, 122-2, 122-N). For example, the virtual desktop client (e.g., 122-1, 122-2, 122-N) can be a stand-alone, designated client application (“native client”), or a web browser (“web client”). In some cases, a standard web browser may be modified with a plugin to operate as a web client. The interaction between the virtual desktop and the client device can be facilitated by such a virtual desktop client (e.g., 122-1, 122-2, 122-N) running in the OS (e.g., 121-1, 121-2, 121-N) on the client device (e.g., 120-1, 120-2, 120-N) which communicates with a server-side virtual desktop agent (e.g., 103-1, 103-2, 103-N) that is running on the guest OS inside the virtual machine (e.g., 110-1, 110-2, 110-N). In one embodiment, the interaction is performed by the virtual desktop agent transmitting encoded visual display information (e.g., framebuffer pixel data) over the network to the virtual desktop client and the virtual desktop client in turn transmitting user input events (e.g. keyboard, mouse, touch input events) to the remote desktop agent. Interactions between the virtual desktop client (e.g., 122-1, 122-2, 122-N) and the virtual desktop agent (e.g. 103-1, 103-2, 103-N), including transmission of encoded visual display information from the agent to the client and user input events from the client to the agent can be performed using a remote display protocol, such as Remote Desktop Protocol (RDP), PC-over-IP protocol (PCoIP), VMware Blast protocol, Virtual Network Computing (VNC) protocol, or the like.

It should be noted that the particular virtual desktop environment illustrated in FIG. 1 is shown purely for purposes of illustration and is not intended to be in any way inclusive or limiting to the embodiments that are described herein. For example, a typical enterprise VDI deployment might include many host servers, which may be distributed over multiple data centers, which can include many other types of devices, such as switches, power supplies, cooling systems, environmental controls, and the like, which are not illustrated herein. Similarly, a single host server would typically host many more virtual machines than the number shown in this illustration. It will be apparent to one of ordinary skill in the art that the example shown in FIG. 1, as well as all other figures in this disclosure have been simplified for ease of understanding and are not intended to be exhaustive or limiting to the scope of the invention.

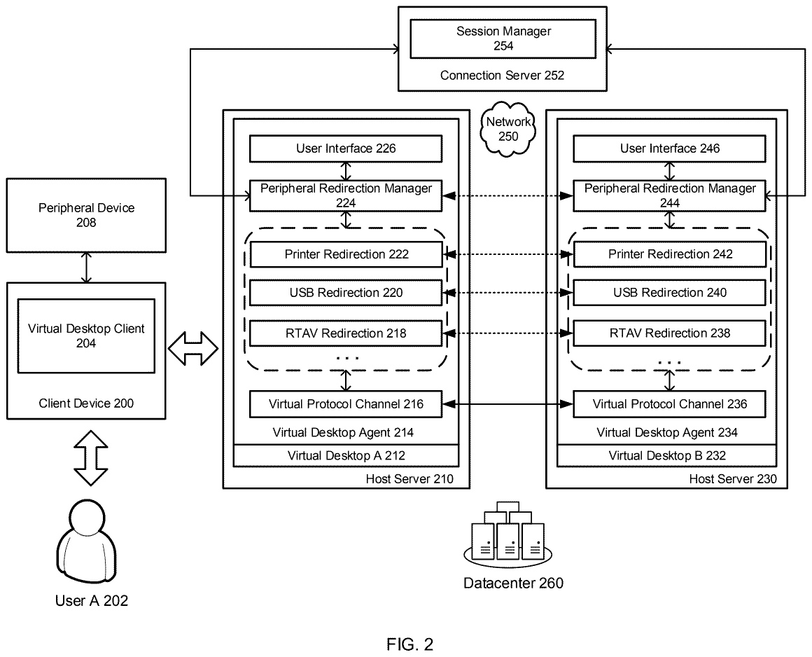

FIG. 2 illustrates an example architecture of a system for redirecting peripheral devices between remote desktops, in accordance with various embodiments. As shown in the illustration, user A 202 uses their client device 200 to establish a remoting session with virtual desktop A 212 running on a host server 210 by contacting the connection server 252. The host server 210 can be physically located in a datacenter 260 that is remotely located with respect to the user's client device 200 and the connection to virtual desktop A 212 is established over the network 250, such as the Internet. As previously described, during the remoting session, the virtual desktop agent 214 regularly sends UI display data to the virtual desktop client 204. Similarly, the virtual desktop agent 214 receives user input data (keyboard and mouse events) from the virtual desktop client 204 to allow the user A 202 to access and control virtual desktop A 212.

A peripheral device 208 is connected to the client device 200. The peripheral device 208 can be any type, such as an audio device, camera, keyboard, mouse or other pointing device, printer, scanner, USB device, etc. The peripheral device 208 can be redirected from the client device 200 to virtual desktop A 212 so that the peripheral device 208 becomes visible and usable in the virtual desktop. This way, when the user accesses virtual desktop A 212, they can see the device 208 in the virtual desktop 212 and use it in the virtual desktop A 212 in much the same way as the user can see and use the device 208 on the local client device 200 system.

Peripheral device redirection components in the virtual desktop A agent 214 can communicate with corresponding components in the virtual desktop client 204 to exchange information for enabling redirection of the peripheral device 208. For example, a printer redirection component 222 can communicate with the virtual desktop client 204 (or with a corresponding client-side printer redirection component in the client 204) to exchange information as necessary for redirecting printer peripheral devices (e.g., if the peripheral device 208 is a printer). A USB redirection component 220 can communicate with the virtual desktop client 204 (or with a corresponding client-side USB redirection component in the client 204) to exchange information as necessary for redirecting USB peripheral devices (e.g., if the peripheral device 208 is a USB device). An RTAV (Reat-Time Audio-Video redirection component 220 can communicate with the virtual desktop client 204 (or with a corresponding client-side RTAV redirection component in the client 204) to exchange information as necessary for redirecting RTAV peripheral devices (e.g., if the peripheral device 208 is a camera, microphone, speaker, etc. device). While this example illustrates only these three redirection components, in other scenarios additional redirection components may be utilized for redirecting other types of devices.

Peripheral device redirection from a client device to a virtual desktop, such as redirection of the peripheral device 208 from the client device 200 to the desktop A 212 in this example, is well known in the art and the particulars of this mechanism will not be discussed herein so as not to obscure the salient parts of the invention. In various embodiments, the redirection components 218, 220, 222 can contain the functionality for redirecting the peripheral device 208 from the client device 200 to the virtual desktop A 212 and additionally contain functionality for redirecting the peripheral device 208 from desktop A 212 to desktop B 232, as described herein.

In various embodiments, after the remote desktop session on desktop A 212 is established and the peripheral device 208 is redirected to desktop A 212, the peripheral device 208 can further be redirected from virtual desktop A 212 to another desktop, virtual desktop B 232, to enable the peripheral device 208 to be visible and usable in virtual desktop B 232.

Virtual desktop B 232 can belong to the same user A 202 or to another user. In either case, virtual desktop B 232 is accessed via a different virtual desktop client than the illustrated client 204, and the virtual desktop client accessing desktop B 232 can run on a different client device than the illustrated client device 200. Virtual desktop B can be hosted on a host server 230. In this example, desktop B 232 is hosted on a different server but in other embodiments the desktops can be hosted on the same server. The host servers can also be in the same datacenter 260, as illustrated, or in different datacenters in other embodiments.

As described previously, after establishing the virtual desktop session on desktop A 212 with the peripheral device 208 being redirected to desktop A 212, if the user desires the peripheral device 208 to be accessible in virtual desktop B 232, which may belong to user A 202 or to a different user, the user can request virtual desktop A 212 to redirect the peripheral device 208 to virtual desktop B 232 (e.g., via a user interface (UI) on virtual desktop A 212). An invitation to accept sharing of the peripheral device 208 can be sent to virtual desktop B 232 and once the invitation is accepted (e.g., by the user of virtual desktop B 232 accepting via a pop-up dialog in desktop B), the peripheral device 208 can be redirected to virtual desktop B 232 from virtual desktop A 212.

After the peripheral device is successfully redirected to desktop B 232 from desktop A 212, the user of desktop B (whether the same user A 202 or a different user) can find and see the shared device 208 on remote desktop B and use the peripheral device 208 in desktop B 232 just like other devices that are redirected to desktop B 232 from a local device (e.g., from the local device being used to access desktop B 232). For example, if the device 208 is a printer, then both desktop A 212 and desktop B 232 may be able to print documents opened in the corresponding desktop to the printer 208. If the device 208 is a USB device (e.g., a storage device), then both desktop A 212 and desktop B 232 may be able to access the USB device 208 in the corresponding desktop (e.g., access files on the USB storage device).

### Session Manager 254

In various embodiments, the connection server 252 contains a session manager module 254. The session manager module 254 can be responsible for traditional functions of authorizing and managing virtual desktop sessions between local devices (e.g., 200) and remote desktops, such as remote desktop A 212 and B 232, as well as for carrying out various functions of this invention. In various embodiments, when user A 202 on remote desktop A 212 requests to share the peripheral device 208 with user B of desktop B 232, the request is first sent to the connection server 252. The connection server 252 checks if user B has an active remote desktop session. If user B does, the connection server 252 will send a notification to all active remote desktops of user B (in this case, desktop B 232). User B, while working on remote desktop B 232, receives the notification of the request from user A 202 and can select to accept the device redirection request or deny it. Once user B accepts the invitation (e.g., clicks the “Accept” button), the connection server 252 will request a session token from remote desktop A 212 and send it to remote desktop B 232, which will then communicate with remote desktop A 212 and establish a connection between the two remote desktops using the obtained token.

### User Interface 226, 246

In various embodiments, the desktop A agent 214 and the desktop B agent 234 can contain corresponding user interfaces (UIs) 226, 246, through which users can manage and control the sharing of peripheral devices (e.g., device 208) between virtual desktops (e.g., desktop A 212 and B 232).

Via the UI 226, user A 202 can select the peripheral device 208 that user A 202 wants to share with remote desktop B 232. For example, user A 202 can be provided with a list of peripheral devices available to be redirected to another desktop (from which list the user 202 can select the peripheral device 208) or user A 202 can be provided a search field where the user can search for peripheral devices available to be redirected from desktop A 212.

Via the UI 226, user A 202 can send a request to other users for sharing the selected device 208. For example, the request to share the peripheral device 208 can be sent to user B of desktop B 232. The request can also be sent to another desktop of user A if they are attempting to share the peripheral device 208 with a different desktop belonging to user A 202.

Via the UI 226, user B of desktop B 232 can be notified (e.g., via a dialog) of the device sharing request sent from user A 202, and user B can select to accept device 208 redirection on desktop B 232 or deny it.

After the peripheral device 208 is redirected from desktop A 212 to desktop B 232, the UIs 226, 246 can be used by the users to view the information of device sharing (e.g., what device and with/from whom it is being shared) and manage the peripheral device 208 sharing. For example, user A 202 can stop sharing the peripheral device 208 by desktop A 212 via the UI 226, or user B can stop the sharing of the peripheral device 208 with desktop B 232 via the UI 246.

### Peripheral Redirection Manager 224, 244

Peripheral redirection manager modules 224, 244 on desktop A 212 and desktop B 232, respectively, play a key role in the system, carrying out various functions.

When user A 202 requests to share the peripheral device 208 with user B via the UI 226, the request is sent to the peripheral redirection manager 224 in desktop A 212 that then forwards the request to the connection server 252, which then checks if there are any active remote desktops for user B and sends the request to all active remote desktops for user B. The peripheral redirection manager 244 on remote desktop B 232 will handle this request and work with the desktop B UI 246 to notify user B of the device sharing request and prompt the user to accept or reject the request. If user B rejects the device sharing request (e.g., by clicking a “Deny” button on the notification dialog), the peripheral redirection manager will notify the connection server 252 of the rejection, which will then inform user A that the device sharing request was declined. If user B accepts the request (e.g., clicks an “Accept” button), the peripheral redirection manager on remote desktop B 232 will communicate with remote desktop A 212 to establish a connection and a virtual protocol channel between these two remote desktops for data transfer for performing the device 208 redirection from desktop A 212 to desktop B 232.

The desktop A peripheral redirection manager 224 can work with the counterpart desktop B peripheral redirection manager 244 to coordinate printer redirection, USB redirection, RTAV redirection, and any other type of device redirection between the desktops 212, 232.

Any UI 226, 246 event triggered by user A or user B will go to the corresponding peripheral redirection manager 224, 246 on the desktop, which will handle the event accordingly. For example, when user A or B stops device sharing via the UI 226, 246, respectively, this event will be sent to the respecting peripheral redirection manager 226, 246 on the user's desktop, which will then work with the peripheral redirection manager 246, 226 on the other remote desktop 232, 212 to end the connection between the two remote desktops 212, 232.

The peripheral redirection managers 224, 244 can continuously monitor the connection between local OSes and remote desktops 212, 232. If user A 202 or user B disconnects from their corresponding remote desktop 212, 232, the corresponding peripheral redirection manager 224, 244 will get notified and start to work with corresponding redirection modules (such as printer redirection 222, 242, USB redirection 220, 240, RTAV redirection 218, 238 and so on) to end the device-sharing session.

### Printer Redirection 222, 242

For performing standard client-to-remote desktop printer device redirection, the printer redirection module 222 can work with a counterpart module (not illustrated) on the virtual desktop client 204 to redirect a printer (e.g., device 208) on the local device 200 to the remote desktop A 212. In various embodiments, new logic can be added to the printer redirection module 222 component so that it can further redirect the printer (e.g., device 208) from desktop A 212 to desktop B 232 by working with the counterpart printer redirection module 242 in desktop B 232.

### USB Redirection 220, 240

For performing standard client-to-remote desktop USB device redirection, the USB redirection module 220 can work with a counterpart module (not illustrated) on the virtual desktop client 204 to redirect a USB device (e.g., device 208) on the local device 200 to the remote desktop A 212. In various embodiments, new logic can be added to the USB redirection module 220 component so that it can further redirect the USB device (e.g., device 208) from desktop A 212 to desktop B 232 by working with the counterpart USB redirection module 240 in desktop B 232.

### RTAV Redirection 218, 238

For performing standard client-to-remote desktop RTAV redirection, an RTAV redirection client module on the local device 200 works with an RTAV redirection server (which is part of the RTAV redirection module 218) on the remote desktop A 212 to transfer audio and video streams between the local side and remote desktop A 212. In various embodiments, both the RTAV redirection client and an RTAV redirection server can be implemented in the RTAV redirection module 218 to transfer audio and video streams from desktop A 212 to desktop B 232 by working with the counterpart RTAV redirection module 238 in desktop B 232. As a result, user A 202 can redirect audio and video related peripheral devices (such as camera, microphone, speaker etc.) from remote desktop A 212 to remote desktop B 232.

### Virtual Protocol Channel Modules 216, 236

In standard virtual desktop infrastructure, a virtual protocol channel is implemented for data transfer between the client device and the remote desktop. The virtual protocol channel utilizes corresponding virtual protocol channel modules on the client device and the virtual desktop. In various embodiments, the implementation of the protocol virtual channel and the corresponding virtual protocol channel modules 216, 236 on the desktops 212, 232 can be modified so that the virtual channel is established between two remote desktops 212, 232 for data transfer used in device redirection, such as printer redirection, USB redirection, RTAV redirection, etc. between the desktops 212, 232.

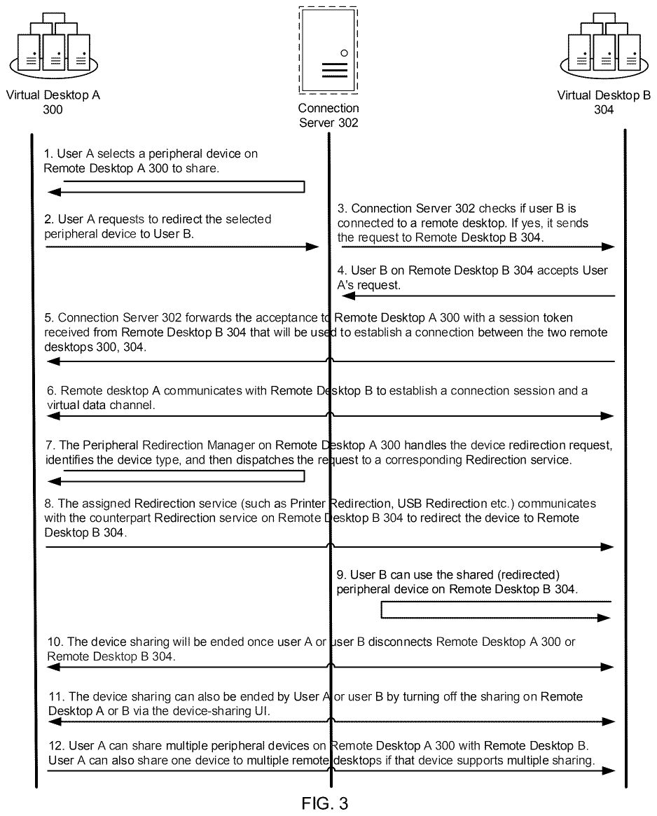

FIG. 3 is an illustration of a process flow between virtual desktop A, the connection server, and virtual desktop B, in accordance with various embodiments. The process can begin after user A has established a virtual desktop session on virtual desktop A 300 via a virtual desktop client running on the user's client device, where one or more peripheral device on the client device have been redirected to virtual desktop A so that user A is able to see and use the peripheral device in virtual desktop A 300.

As illustrated in step (1), User A of virtual desktop A 300 selects a peripheral device on Remote Desktop A 300 that the user desires to share with another desktop or another user. In step (2) User A requests to redirect the selected peripheral device to User B. In step (3) the Connection Server 302 checks if user B is connected to a remote desktop. If user B is connected to remote desktop B, the Connection Server 302 sends User A's request to Remote Desktop B 304.

In step (4), User B on Remote Desktop B 304 accepts User A's request. In step (5), the Connection Server 302 forwards User B's request acceptance to Remote Desktop A 300 with a session token received from Remote Desktop B 304 that will be used to establish a connection between the two remote desktops 300, 304. In step (6), Remote desktop A communicates with Remote Desktop B to establish a connection session and a virtual data channel for transferring data between the desktops used in device redirection. In step (7), the Peripheral Redirection Manager on Remote Desktop A 300 handles the device redirection request, identifies the device type, and then dispatches the request to a corresponding Redirection service (e.g., to a Printer Redirection module, a USB redirection module, etc. on virtual desktop A 300, depending on the type of device being redirected). In step (8), the assigned Redirection service (such as Printer Redirection, USB Redirection etc.) communicates with the counterpart Redirection service on Remote Desktop B 304 to redirect the device to Remote Desktop B 304. In step (9), User B can use the shared (redirected) peripheral device on Remote Desktop B 304.

In step (10), the device sharing will be ended once user A or user B disconnects Remote Desktop A 300 or Remote Desktop B 304, respectively. In step (11) the device sharing can also be ended by User A or user B by turning off the sharing on Remote Desktop A or B via the device-sharing UI. In step (12) User A can share multiple peripheral devices on Remote Desktop A 300 with Remote Desktop B. User A can also share one device to multiple remote desktops if that device supports multiple sharing.

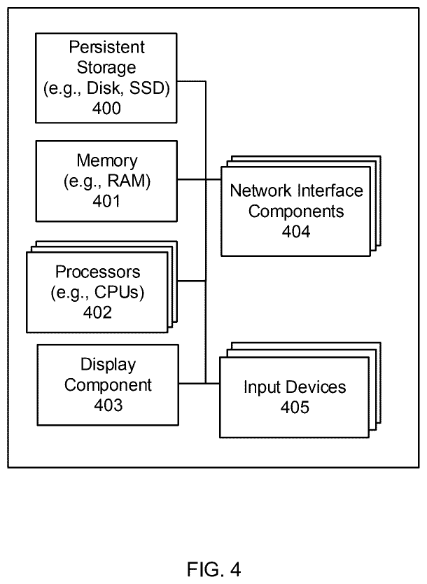

FIG. 4 illustrates an example of some general components of a computing device, in accordance with various embodiments. In this particular example, the device includes one or more processors (e.g., central processing units (CPUs) 402 for executing instructions that can be stored in a storage medium component. The storage medium can include many types of memory, persistent data storage, or non-transitory computer-readable storage media. For example, the storage medium may take the form of random access memory (RAM) 401 storing program instructions for execution by the processor(s) 402, a persistent storage (e.g., disk or SSD) 400, a removable memory for sharing information with other devices and/or the like. The computing device typically can further comprise a display component 403, such as a monitor, a touch screen, liquid crystal display (LCD), or the like. In various embodiments, the computing device will include at least one input device 405 able to receive conventional input from a user. This conventional input can include, for example, a push button, touch pad, touch screen, wheel, joystick, keyboard, mouse, keypad, or any other such device or element whereby a user can input a command to the device. In some embodiments, the computing device can include a network interface component (NIC) 404 for communicating over various networks, such as a Wi-Fi®, Bluetooth®, RF, wired, or wireless communication systems. The device in many embodiments can communicate over a network, such as the Internet, and may be able to communicate with other devices connected to the same or other network.

Various embodiments described herein can be implemented in a wide variety of environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Many embodiments utilize at least one network that would be familiar to those skilled in the art for supporting communications using any of a variety of commercially-available protocols, such as TCP/IP, FTP, UDP or the like. The network can be, for example, a local area network, a wide-area network, a virtual private network, the Internet, an intranet, an extranet, a public switched telephone network, an infrared network, a wireless network, and any combination thereof.

The various environments in which the embodiments can be implemented may include a variety of data stores and other memory and storage media, as discussed above. These can reside in a variety of locations, such as on a storage medium local to one or more of the computers or remote from any or all of the computers across the network. In some embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A method, comprising:
by a virtual desktop client operating on a client device, establishing a virtual desktop session on a first virtual desktop;
redirecting a peripheral device connected to the client device to the first virtual desktop to make the peripheral device usable in the first virtual desktop;
establishing a connection between the first virtual desktop and a second virtual desktop; and
using the connection, redirecting the peripheral device connected to the client device from the first virtual desktop to the second virtual desktop to make the peripheral device usable in the second virtual desktop.

2. The method of claim 1, further comprising:
at the first virtual desktop, receiving a request from a first user to redirect the peripheral device from the first virtual desktop to a virtual desktop of a second user.

3. The method of claim 2, further comprising:
sending the request to a connection server; and
by the connection server, forwarding the request to the second virtual desktop.

4. The method of claim 3, further comprising:
on the second virtual desktop, presenting a user interface dialog prompting the second user of the second virtual desktop to accept or reject redirecting the peripheral device to the second virtual desktop.

5. The method of claim 2, further comprising;
sending the request to a connection server; and
by the connection server:
checking which virtual desktops the second user is connected to;
identifying one or more virtual desktops that the second user is connected to including the second virtual desktop; and
by the connection server, forwarding the request to the one or more virtual desktops that the second user is connected to including the second virtual desktop.

6. The method of claim 1, wherein the peripheral device is a printer connected to the client device and further comprising, after the peripheral device is redirected to the second virtual desktop, printing a document by the second virtual desktop on the printer connected to the client device.

7. The method of claim 1, wherein the peripheral device is a USB device connected to the client device and further comprising, after the peripheral device is redirected to the second virtual desktop, accessing the USB device connected to the client device by the second virtual desktop.

8. A computing device, comprising:
at least one processor; and
memory including instructions that, when executed by the at least one processor, cause the computing device to perform the steps of:
by a virtual desktop client operating on a client device, establishing a virtual desktop session on a first virtual desktop;
redirecting a peripheral device connected to the client device to the first virtual desktop to make the peripheral device usable in the first virtual desktop;
establishing a connection between the first virtual desktop and a second virtual desktop; and
using the connection, redirecting the peripheral device connected to the client device from the first virtual desktop to the second virtual desktop to make the peripheral device usable in the second virtual desktop.

9. The computing device of claim 8, wherein the memory further includes instructions that when executed by the at least one processor, cause the computing device to perform the steps of:
at the first virtual desktop, receiving a request from a first user to redirect the peripheral device from the first virtual desktop to a virtual desktop of a second user.

10. The computing device of claim 9, wherein the memory further includes instructions that when executed by the at least one processor, cause the computing device to perform the steps of:
sending the request to a connection server; and
by the connection server, forwarding the request to the second virtual desktop.

11. The computing device of claim 10, wherein the memory further includes instructions that when executed by the at least one processor, cause the computing device to perform the steps of:
on the second virtual desktop, presenting a user interface dialog prompting the second user of the second virtual desktop to accept or reject redirecting the peripheral device to the second virtual desktop.

12. The computing device of claim 9, wherein the memory further includes instructions that when executed by the at least one processor, cause the computing device to perform the steps of:
sending the request to a connection server; and
by the connection server:
checking which virtual desktops the second user is connected to;
identifying one or more virtual desktops that the second user is connected to including the second virtual desktop; and
by the connection server, forwarding the request to the one or more virtual desktops that the second user is connected to including the second virtual desktop.

13. The computing device of claim 8, wherein the peripheral device is a printer connected to the client device and further comprising, after the peripheral device is redirected to the second virtual desktop, printing a document by the second virtual desktop on the printer connected to the client device.

14. The computing device of claim 8, wherein the peripheral device is a USB device connected to the client device and further comprising, after the peripheral device is redirected to the second virtual desktop, accessing the USB device connected to the client device by the second virtual desktop.

15. A non-transitory computer readable storage medium comprising one or more sequences of instructions, the instructions when executed by one or more processors causing the one or more processors to execute the operations of:
by a virtual desktop client operating on a client device, establishing a virtual desktop session on a first virtual desktop;
redirecting a peripheral device connected to the client device to the first virtual desktop to make the peripheral device usable in the first virtual desktop;
establishing a connection between the first virtual desktop and a second virtual desktop; and
using the connection, redirecting the peripheral device connected to the client device from the first virtual desktop to the second virtual desktop to make the peripheral device usable in the second virtual desktop.

16. The non-transitory computer readable storage medium of claim 15, further comprising instructions that when executed by the one or more processors cause the one or more processors to execute the operations of:
at the first virtual desktop, receiving a request from a first user to redirect the peripheral device from the first virtual desktop to a virtual desktop of a second user.

17. The non-transitory computer readable storage medium of claim 16, further comprising instructions that when executed by the one or more processors cause the one or more processors to execute the operations of:
sending the request to a connection server; and
by the connection server, forwarding the request to the second virtual desktop.

18. The non-transitory computer readable storage medium of claim 17, further comprising instructions that when executed by the one or more processors cause the one or more processors to execute the operations of:
on the second virtual desktop, presenting a user interface dialog prompting the second user of the second virtual desktop to accept or reject redirecting the peripheral device to the second virtual desktop.

19. The non-transitory computer readable storage medium of claim 16, further comprising instructions that when executed by the one or more processors cause the one or more processors to execute the operations of:
sending the request to a connection server; and
by the connection server:
checking which virtual desktops the second user is connected to;
identifying one or more virtual desktops that the second user is connected to including the second virtual desktop; and
by the connection server, forwarding the request to the one or more virtual desktops that the second user is connected to including the second virtual desktop.

20. The non-transitory computer readable storage medium of claim 15, wherein the peripheral device is a printer connected to the client device and further comprising, after the peripheral device is redirected to the second virtual desktop, printing a document by the second virtual desktop on the printer connected to the client device.
